(19) United States
(12) Patent Application Publication
(10) Pub. No.: US 2016/0119942 A1
(43) Pub. Date: Apr. 28, 2016

(54) SYSTEMS AND METHODS FOR ALIGNING MULTIPLE RADIO ACCESS TECHNOLOGIES

(71) Applicant: QUALCOMM Incorporated, San Diego, CA (US)

(72) Inventor: Jibing Wang, San Diego, CA (US)

(21) Appl. No.: 14/523,603

(22) Filed: Oct. 24, 2014

(51) Int. Cl. H04W 72/12; H04B 7/04; H04W 88/08; H04B 7/06

(52) U.S. Cl. CPC H04W 72/1205; H04B 7/0632; H04B 7/0413; H04W 88/08

(57) ABSTRACT

A method is described. The method includes determining channel quality report timing for a first radio access technology (RAT). The method also includes aligning scan timing for a second RAT with the channel quality report timing of the first RAT. The method further includes sending a first channel quality report to a base station that indicates lower-rank multiple-input and multiple-output (MIMO) is available for the first RAT when the second RAT performs a scan. The method additionally includes sending a second channel quality report to the base station that indicates higher-rank MIMO is available upon completion of the scan.

### TECHNICAL FIELD

The present disclosure relates generally to wireless communication devices. More specifically, the present disclosure relates to systems and methods for aligning multiple radio access technologies (RATs).

### BACKGROUND

The use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some wireless communication devices (e.g., smartphones) transmit wireless signals. For example, the wireless signals may be utilized to communicate with wireless communication devices. In some cases, a wireless communication device may include multiple wireless communication technologies. Inefficiencies may occur when the multiple communication technologies are out of alignment. Therefore, systems and methods for aligning multiple wireless communication technologies may be beneficial.

### SUMMARY

A method is described. The method includes determining channel quality report timing for a first radio access technology (RAT). The method also includes aligning scan timing for a second RAT with the channel quality report timing of the first RAT. The method further includes sending a first channel quality report to a base station that indicates lower-rank multiple-input and multiple-output (MIMO) is available for the first RAT when the second RAT performs a scan. The method additionally includes sending a second channel quality report to the base station that indicates higher-rank MIMO is available upon completion of the scan.

Aligning the scan timing for the second RAT with the channel quality report timing of the first RAT comprises may include adjusting a scan start time to align with sending the first channel quality report for the first RAT. A scan end time may be adjusted to align with sending the second channel quality report for the first RAT.

The lower-rank MIMO may use fewer antennas for MIMO operations than the higher-rank MIMO.

The method may also include switching to the lower-rank MIMO for the first RAT based on the first channel quality report. The method may further include starting the scan of the second RAT. The method may additionally include switching to the higher-rank MIMO for the first RAT upon completion of the scan based on the second channel quality report.

The method may also include allocating a shared antenna to the second RAT when the second RAT starts the scan. The first RAT may perform lower-rank MIMO operations using two or more non-shared antennas during a scan interval. The method may further include allocating the shared antenna to the first RAT when the second RAT completes the scan. The first RAT may perform higher-rank MIMO operations using the shared antenna and the two or more non-shared antennas.

The first RAT may be Long-Term Evolution (LTE) and the second RAT may be Bluetooth (BT). The channel quality report may include a channel quality indicator (CQI) and a rank indicator (RI). The method may be performed by a wireless communication device.

A wireless communication device is also described. The wireless communication device includes a processor, memory in electronic communication with the processor, and instructions stored in the memory. The instructions are executable by the processor to determine channel quality report timing for a first RAT. The instructions are also executable to align scan timing for a second RAT with the channel quality report timing of the first RAT. The instructions are further executable to send a first channel quality report to a base station that indicates lower-rank MIMO is available for the first RAT when the second RAT performs a scan. The instructions are additionally executable to send a second channel quality report to the base station that indicates higher-rank MIMO is available upon completion of the scan.

An apparatus is also described. The apparatus includes means for determining channel quality report timing for a first RAT. The apparatus also includes means for aligning scan timing for a second RAT with the channel quality report timing of the first RAT. The apparatus further includes means for sending a first channel quality report to a base station that indicates lower-rank MIMO is available for the first RAT when the second RAT performs a scan. The apparatus additionally includes means for sending a second channel quality report to the base station that indicates higher-rank MIMO is available upon completion of the scan.

### BRIEF DESCRIPTION OF THE DRAWINGS

FIG. 1 is a block diagram illustrating one configuration of a wireless communication device in which systems and methods for aligning multiple radio access technologies (RATs) may be implemented;

FIG. 2 is a flow diagram illustrating a method for aligning multiple radio access technologies (RATs);

FIG. 3 is a graph illustrating a non-aligned scenario and an aligned scenario for multiple RAT operation;

FIG. 4 is a block diagram illustrating a detailed configuration of a wireless communication device in which systems and methods for aligning multiple RATs may be implemented;

FIG. 5 is a flow diagram illustrating a method for aligning multiple radio access technologies (RATs);

FIG. 6 is a block diagram of a transmitter and receiver in a multiple-input and multiple-output (MIMO) system; and

FIG. 7 illustrates various components that may be utilized in a wireless communication device.

### DETAILED DESCRIPTION

The systems and methods disclosed herein may be applied to communication devices that communicate wirelessly. For example, some communication devices may communicate with other devices using wireless communication technologies. In one configuration, the systems and methods disclosed herein may be applied to a wireless communication device that includes multiple radio access technologies (RATs). For example, a first RAT may be long-term evolution (LTE) and the second RAT may be Bluetooth (BT).

In one configuration, a wireless communication device may share an antenna between two RATs. For example, the first RAT may use the shared antenna when the second RAT is idle. When the second RAT needs to perform a wireless communication operation, the wireless communication device may allocate the shared antenna to the second RAT.

Problems may occur if the timing of the first RAT and the second RAT are not aligned. For example, the first RAT may be communicating with a base station that expects that a certain number of antennas are available. If the shared antenna is switched to the second RAT, data sent by the base station to the first RAT may be lost until the first RAT notifies the base station that fewer antennas are available.

Various configurations are now described with reference to the Figures. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

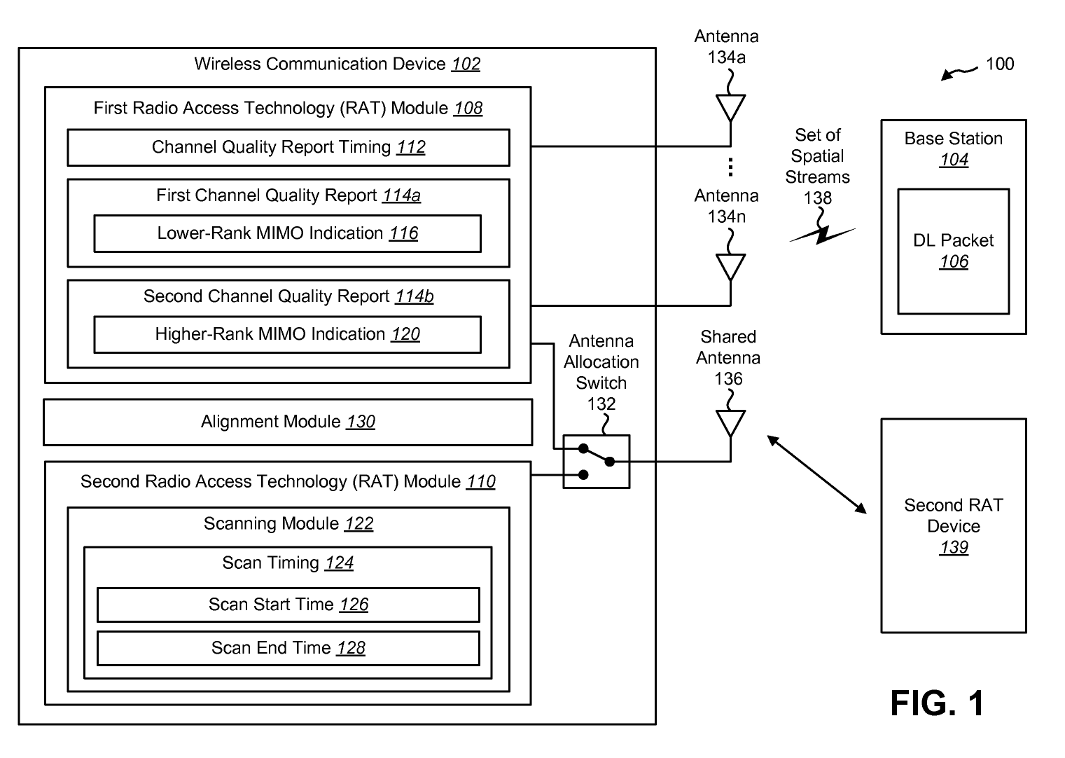

FIG. 1 is a block diagram illustrating one configuration of a wireless communication device 102 in which systems and methods for aligning multiple radio access technologies (RATs) may be implemented. Wireless communication systems 100 are widely deployed to provide various types of communication content such as voice, data, and so on. A wireless device may be a wireless communication device 102 or a base station 104.

A base station 104 is a station that may communicate with one or more wireless communication devices 102. A base station 104 may also be referred to as, and may include some or all of the functionality of an access point, a broadcast transmitter, a NodeB, an evolved NodeB, a base transceiver station, etc. The term “base station” will be used herein. Each base station 104 may provide communication coverage for a particular geographic area. A base station 104 may provide communication coverage for one or more wireless communication devices 102. The term “cell” can refer to a base station 104, the coverage area of the base station 104 and/or communication channels between the base station 104 and wireless communication device 102 depending on the context in which the term is used. A single base station 104 may provide one or more cells.

The wireless communication device 102 may also be referred to as, and may include some or all of the functionality of, a terminal, an access terminal, a subscriber unit, a station, a user equipment (UE), etc. Examples of the wireless communication device 102 may include a cellular phone, a personal digital assistant (PDA), a wireless device, a wireless modem, a handheld device, a laptop computer, a session initiation protocol (SIP) phone, a wireless local loop (WLL) station, entertainment device, appliance, business/household device, visual display, automotive/vehicle component, sensor, actuator, solar array, etc. Each component of the wireless communication device 102 described herein may be implemented in hardware (e.g., circuitry) or a combination of hardware and software (e.g., a processor with executable instructions stored in memory).

A wireless communication device 102, and base station 104 may operate in accordance with certain industry standards, such as Third Generation Partnership Project (3GPP) Long Term Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, Bluetooth standards, IEEE 802.16 (e.g., Worldwide Interoperability for Microwave Access or “WiMAX”) standards, Code Division Multiple Access (CDMA) 2000 1× (referred to herein as “1×”, may also be referred to as IS-2000 or 1×RTT) standards, Evolution-Data Optimized (EVDO) standards, Interim Standard 95 (IS-95), High Rate Packet Data (HRPD), evolved High Rate Packet Data (eHRPD) radio standards and others. While some of the systems and methods disclosed herein may be described in terms of one or more standards, this should not limit the scope of the disclosure, as the systems and methods may be applicable to many systems and/or standards.

The terms “networks” and “systems” are often used interchangeably. A CDMA network may implement a radio access technology (RAT) such as Universal Terrestrial Radio Access (UTRA), CDMA2000, etc. UTRA includes W-CDMA and Low Chip Rate (LCR) while CDMA2000 covers IS-2000, IS-95 and IS-856 standards. A TDMA network may implement a radio access technology (RAT) such as Global System for Mobile Communications (GSM). An orthogonal frequency division multiple access (OFDMA) network may implement a radio access technology (RAT) such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). Additionally, CDMA2000 is described in documents from an organization named “3rd Generation Partnership Project 2” (3GPP2).

As used herein, the term “system” may refer to a communication system, a telecommunication system, a mobile telecommunication system, a network, a communication network, etc. Additionally, as used herein, the term “system” may refer to a radio access technology (RAT) that may be implemented within a particular system 100.

A wireless communication device 102 may communicate with one or more base stations 104 on a downlink and/or an uplink at any given moment. The downlink (or forward link) refers to the communication link from a base station 104 to a wireless communication device 102, and the uplink (or reverse link) refers to the communication link from a wireless communication device 102 to a base station 104.

Communications between the wireless communication device 102 and base station 104 may be achieved through transmissions over a wireless link. Such a communication link may be established via a single-input and single-output (SISO), multiple-input and single-output (MISO) or a multiple-input and multiple-output (MIMO) system. A multiple-input and multiple-output system includes transmitter(s) and receiver(s) equipped, respectively, with multiple (N_{T}) transmit antennas and multiple (N_{R}) receive antennas for data transmission. Single-input and single-output and multiple-input and single-output systems are particular instances of a multiple-input and multiple-output system. The multiple-input and multiple-output system can provide improved performance (e.g., higher throughput, greater capacity or improved reliability) if the additional dimensionalities created by the multiple transmit and receive antennas are utilized.

In some configurations, the wireless communication device 102 may communicate with other wireless devices using multiple RATs. For example, the wireless communication device 102 may include a first RAT module 108 that may implement a first RAT. In one implementation, the first RAT may be a cellular communication technology (e.g., LTE, W-CDMA, GSM) that may enable the wireless communication device 102 to join a wide area network (WAN).

The wireless communication device 102 may also include a second RAT module 110 that may implement a second RAT. In one implementation, the second RAT may be Bluetooth or Wi-Fi. The second RAT module 110 may communicate with a second RAT device 139 according to the standards of the second RAT.

The first RAT module 108 and the second RAT module 110 may share some common resources. One example of shared resources is a radio frequency (RF) chain (also referred to as a front-end module). An RF chain may include a transmitter RF chain and a receiver RF chain. A transmitter RF chain may include an encoder, modulator, amplifier, mixer, filter and analog to digital converter (ADC). A receiver RF chain may include a decoder, demodulator, mixer filter and digital to analog converter (DAC). An RF chain may be coupled to an antenna.

In another configuration, the first RAT module 108 and the second RAT module 110 may share one or more antennas 136. In FIG. 1, the wireless communication device 102 includes a shared antenna 136 that is coupled to the first RAT module 108 and the second RAT module 110. The shared antenna 136 may be allocated to either the first RAT module 108 or the second RAT module 110 via an antenna allocation switch 132. When the second RAT module 110 is active (e.g., performing an activity that uses the shared antenna 136), the shared antenna 136 may be allocated (e.g., switched) to the second RAT module 110. When the second RAT module 110 is not active (e.g., idle or not performing an activity that uses the shared antenna 136), the shared antenna 136 may be allocated to the first RAT module 108.

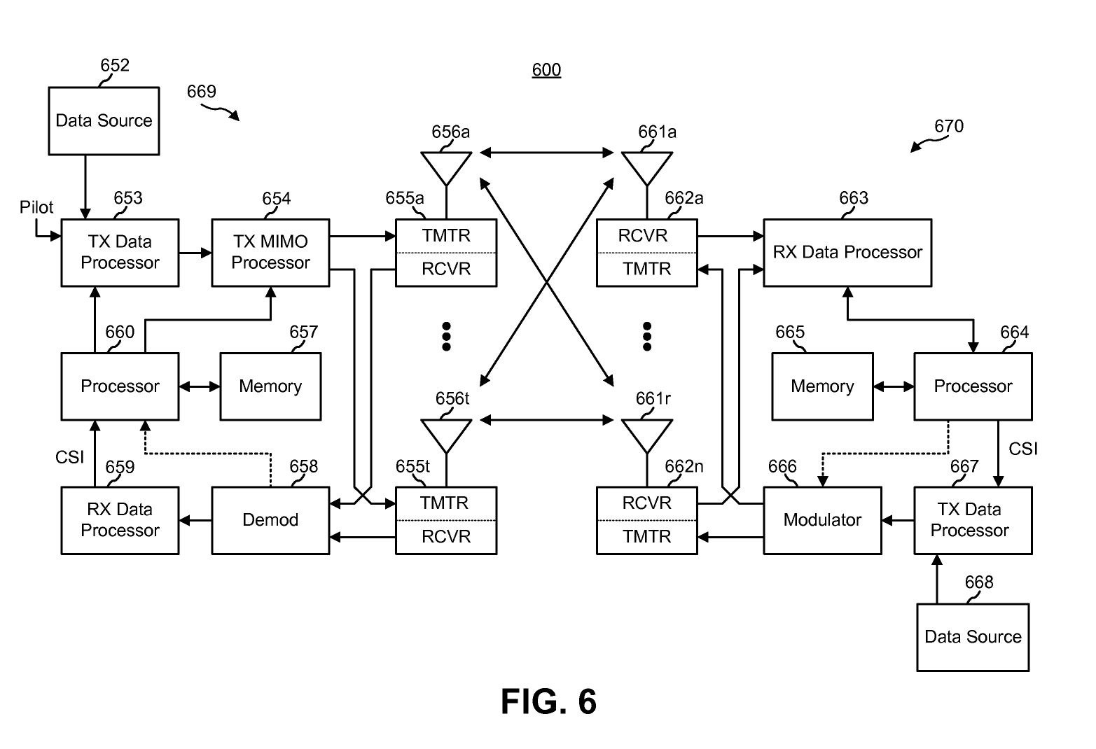

The first RAT module 108 may use MIMO to communicate with the base station 104. With MIMO, the first RAT module 108 may use multiple antennas to transmit and receive data. The first RAT module 108 may be coupled to multiple antennas 134a-n that are not shared with the second RAT module 110. The first RAT module 108 may perform MIMO operations using just the non-shared antennas 134a-n. The first RAT module 108 may also perform MIMO operations using the non-shared antennas 134a-n and the shared antenna 136. MIMO is described in detail in connection with FIG. 6.

The number of antennas 134, 136 available for MIMO may be indicated by a MIMO rank. Lower-rank MIMO has fewer antennas available for MIMO communication than higher-rank MIMO. For example, MIMO communication with two available antennas has a lower rank than MIMO communication with three available antennas. Therefore, when the shared antenna 136 is allocated to the first RAT module 108, higher-rank MIMO is available for the first RAT module 108. However, when the shared antenna 136 is allocated to the second RAT module 110, lower-rank MIMO is available for the first RAT module 108. In other words, fewer antennas 134a are available for MIMO operations on the first RAT module 108 when the shared antenna 136 is allocated to the second RAT module 110.

The first RAT module 108 may periodically feedback the MIMO rank (also referred to as a spatial layer) to the base station 104. The first RAT module 108 may send a channel quality report 114 that indicates the MIMO rank that is available for the first RAT module 108. The channel quality report 114 may include channel quality indicator (CQI) information that indicates a suitable data rate (e.g., a modulation and coding scheme (MCS) value) for downlink transmissions. The channel quality report 114 may also include a rank indicator (RI) that corresponds to the number of useful transmission layers for spatial multiplexing. In other words, the RI may indicate the number of spatial streams 138 that may be used for MIMO communication.

The channel quality report 114 may be sent to the base station 104 on a periodic basis. The first RAT module 108 may follow a channel quality report timing 112 for sending the channel quality report 114. In some configurations, the channel quality report timing 112 may be scheduled by the base station 104. Therefore, the channel quality report timing 112 may be fixed (e.g., established by the base station 104). In the case of LTE, the first RAT module 108 may send a channel quality report 114 to the base station 104 every 10 milliseconds (ms).

MIMO scheduling may be configured by the base station 104 based on the channel quality report 114 sent by the first RAT module 108. If the channel quality report 114 indicates that higher-rank MIMO is available, the base station 104 may schedule a downlink (DL) packet 106 with a set of spatial streams 138 corresponding to the high rank. If the channel quality report 114 indicates that lower-rank MIMO is available, the base station 104 may schedule a downlink (DL) packet 106 with a set of spatial streams 138 corresponding to the low rank.

In one example, the wireless communication device 102 may include two non-shared antennas 134. When the shared antenna 136 is allocated to the first RAT module 108, the first RAT module 108 has three antennas 134, 136 available for MIMO. In this case, the first RAT module 108 may support 3×3 MIMO. In other words, the first RAT module 108 can support a set of three spatial streams 138. In this example, the first RAT module 108 may send a channel quality report 114 indicating that 3×3 MIMO is available. Upon receiving the channel quality report 114, the base station 104 may schedule a DL packet 106 that is formatted for 3 spatial streams 138.

Continuing this example, when the shared antenna is allocated to the second RAT module 110, the first RAT module 108 has two antennas 134 available for MIMO. In this case, the first RAT module 108 may support 2×2 MIMO. In other words, the first RAT module 108 can only support two spatial streams 138. The first RAT module 108 may send a channel quality report 114 indicating that 2×2 MIMO is available. Upon receiving the channel quality report 114, the base station 104 may schedule a DL packet 106 that is formatted for 2 spatial streams 138.

Problems may occur if the shared antenna 136 switches before the first RAT module 108 can inform the base station 104 of the change in shared antenna 136 availability. In one scenario, the shared antenna 136 switches from the first RAT module 108 to the second RAT module 110. If the shared antenna 136 is initially allocated to the first RAT module 108, then the first RAT module 108 may notify the base station 104 that higher-rank MIMO is available. The base station 104 may schedule a DL packet 106 for the higher-rank MIMO. However, if the shared antenna 136 switches to the second RAT module 110 during the higher-rank MIMO transmission, then the DL packet 106 may be dropped until the first RAT module 108 notifies the base station 104 of the switch. The first RAT module 108 cannot receive a DL packet 106 that is formatted for higher-rank MIMO if fewer antennas are available. For example, a 3×3 MIMO DL packet 106 cannot be received with only 2 available antennas 134.

In another scenario, the shared antenna 136 switches from the second RAT module 110 to the first RAT module 108. If the shared antenna 136 is initially allocated to the second RAT module 110, then the first RAT module 108 may notify the base station 104 that lower-rank MIMO is available. The base station 104 may schedule a DL packet 106 for the lower-rank MIMO. However, if the shared antenna 136 switches to the first RAT module 108 during the lower-rank MIMO transmission, then network time and frequency resources may be wasted. In other words, the first RAT module 108 has an additional antenna 136 available for higher-rank MIMO, but until the first RAT module 108 notifies the base station 104 of the availability of higher-rank MIMO, the base station 104 will not schedule the higher-rank MIMO.

In some configurations, the second RAT module 110 may alternate between periods of activity and inactivity. When the second RAT module 110 is active, the wireless communication device 102 may allocate the shared antenna 136 to the second RAT module 110. When the second RAT module 110 is inactive (e.g., idle), the wireless communication device 102 may allocate the shared antenna 136 to the first RAT module 108.

In one configuration, the second RAT module 110 may include a scanning module 122 to perform a scan. In the case of Bluetooth, the scan may be a paging scan or an inquiry scan. The second RAT module 110 may perform the scan to find one or more nearby second RAT devices 139 or stay connected to a previously discovered second RAT device 139.

The scanning module 122 may perform a scan according to a scan timing 124. The second RAT module 110 may periodically wake up at a scan start time 126 and perform a scan for the second RAT devices 139. At the scan end time 128, the second RAT module 110 may enter idle mode. In the case of Bluetooth, the second RAT module 110 may wake up for 10 ms every 1.28 sec to perform a scan. Therefore, at the scan start time 126 when the second RAT module 110 becomes active, the wireless communication device 102 may allocate the shared antenna 136 to the second RAT module 110 to perform a scan. At the scan end time 128 when the second RAT module 110 becomes inactive, the wireless communication device 102 may allocate the shared antenna 136 to the first RAT module 108.

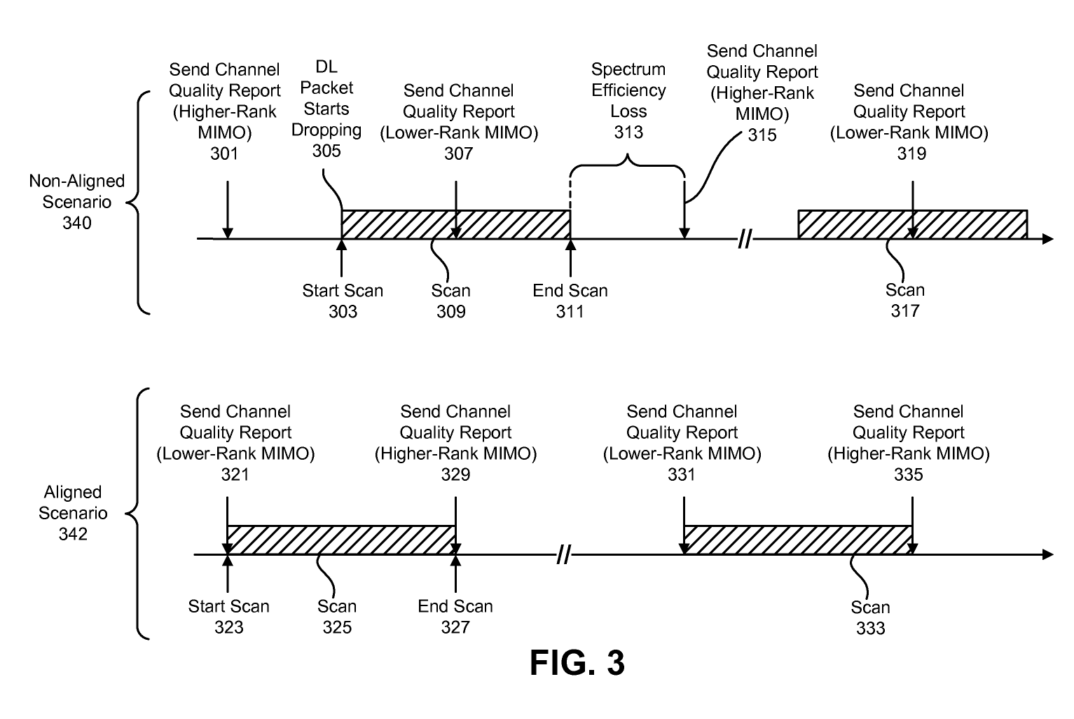

As described above, switching the shared antenna 136 between the first RAT module 108 and the second RAT module 110 may result in dropped DL packets 106 or network resource inefficiencies. When the scan timing 124 of the second RAT module 110 is not aligned with the channel quality report timing 112 of the first RAT module 108, the first RAT module 108 may not notify the base station 104 of a change in the allocation of the shared antenna 136 before packet dropping or resource inefficiency occurs. An example of a non-aligned scenario is described in connection with FIG. 3.

The wireless communication device 102 may include an alignment module 130 to align the scan timing 124 of the second RAT module 110 with the channel quality report timing 112 of the first RAT module 108. The alignment module 130 may determine the channel quality report timing 112 for the first RAT. As discussed above, the first RAT module 108 may receive the channel quality report timing 112 from the base station 104. The alignment module 130 may determine when the first RAT module 108 is scheduled to send channel quality reports 114.

The alignment module 130 may align the scan timing 124 for the second RAT module 110 with the channel quality report timing 112 of the first RAT module 108. The scan timing 124 for the second RAT module 110 may be adjusted, as compared to the channel quality report timing 112 of the first RAT module 108, which is fixed by the base station 104. The alignment module 130 may adjust the scan start time 126 and the scan end time 128 to occur when the first RAT module 108 sends a channel quality report 114. Therefore, the shared antenna 136 availability is consistent with the DL scheduling for the first RAT module 108. An example of an aligned scenario is described in connection with FIG. 3.

In one configuration, the alignment module 130 may adjust the scan start time 126 to align with sending a first channel quality report 114a for the first RAT module 108. The alignment module 130 may adjust the scan end time 128 to align with sending a second channel quality report 114b for the first RAT module 108.

When the wireless communication device 102 switches the shared antenna 136 to the second RAT module 110 to perform a scan, the first RAT module 108 may send the first channel quality report 114a to the base station 104. The first channel quality report 114a may indicate that lower-rank MIMO is available for the first RAT module 108. In one configuration, the lower-rank MIMO indication 116 may be an RI included in the first channel quality report 114a. The RI may indicate the number of antennas 134 available for MIMO operations.

The first RAT module 108 may switch to the lower-rank MIMO based on the first channel quality report 114a. Because the scan start time 126 is adjusted to align with sending the first channel quality report 114a for the first RAT module 108, the base station 104 may schedule lower-rank MIMO when the second RAT module 110 starts the scan. By aligning the scan start time 126 with the first channel quality report 114a, the base station 104 is notified that the first RAT module 108 has fewer antennas available when the second RAT module 110 starts the scan. In this case, the first RAT module 108 may perform lower-rank MIMO operations using the two or more non-shared antennas 134a-n during the scan interval.

When the second RAT module 110 completes the scan, the wireless communication device 102 may allocate the shared antenna 136 to the first RAT module 108. The first RAT module 108 may send the second channel quality report 114b to the base station 104. The first channel quality report 114a may indicate that higher-rank MIMO is available for the first RAT module 108. In one configuration, the higher-rank MIMO indication 120 may be an RI included in the first channel quality report 114a.

The first RAT module 108 may switch to the higher-rank MIMO based on the second channel quality report 114b. Because the scan end time 128 is adjusted to align with sending the second channel quality report 114b by the first RAT module 108, the base station 104 may schedule higher-rank MIMO when the second RAT module 110 becomes inactive and the shared antenna 136 is available to the first RAT module 108. By aligning the scan end time 128 with the second channel quality report 114b, the base station 104 is notified that the first RAT module 108 has more antennas available when the second RAT module 110 completes the scan. In this case, the first RAT module 108 may perform higher-rank MIMO operations using the shared antenna 136 and the two or more non-shared antennas 134a-n.

The alignment module 130 may realign the scan timing 124 with the channel quality report timing 112. In one case, the alignment module 130 may periodically realign the scan timing 124 with the channel quality report timing 112 to account for timing drift between the first RAT module 108 and the second RAT module 110. For example, the alignment module 130 may realign the scan timing 124 with the channel quality report timing 112 every few seconds. In this case, the alignment of the scan timing 124 with the channel quality report timing 112 may occur on a set schedule.

In another case, the alignment module 130 may realign the scan timing 124 with the channel quality report timing 112 because of handover from one base station 104 to another base station 104. Because the channel quality report timing 112 is configured by the base station 104, when the wireless communication device 102 moves from one cell to another cell, the alignment module 130 may realign the scan timing 124 with the channel quality report timing 112 of the new base station 104. In this case, the alignment of the scan timing 124 with the channel quality report timing 112 may occur dynamically.

The systems and methods described herein will reduce power consumption and improve communication reliability. By aligning the scan timing 124 with the channel quality report timing 112 and notifying the base station 104 of the availability of a shared antenna 136 for MIMO operations, the wireless communication device 102 may avoid dropped packets. This may reduce power consumption due to retransmission. This may also improve user experience while using the wireless communication device 102. Furthermore, network resources are efficiently utilized by maximizing the time that higher-layer MIMO is performed.

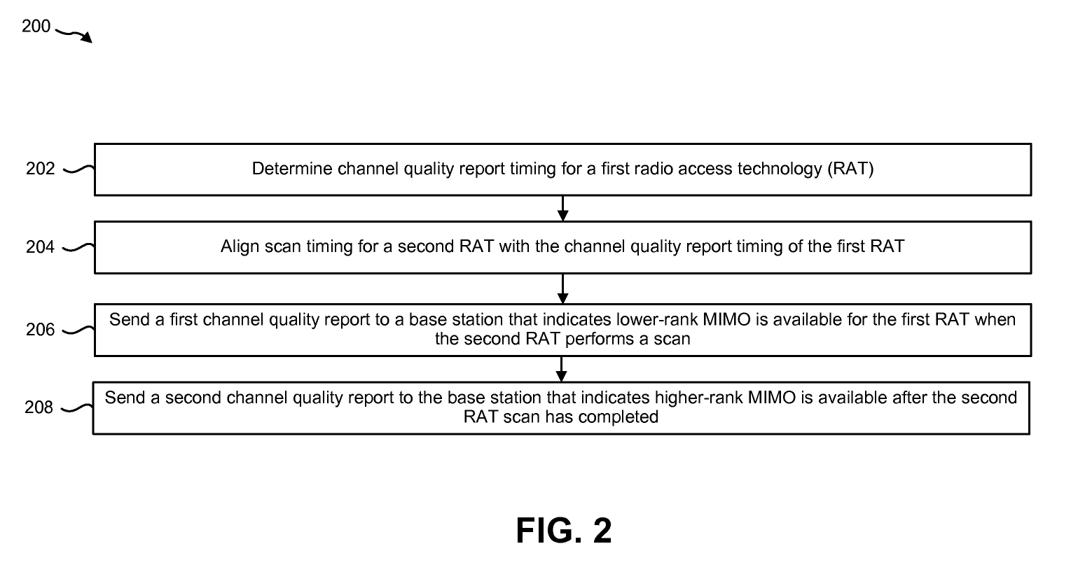

FIG. 2 is a flow diagram illustrating a method 200 for aligning multiple radio access technologies (RATs). The method 200 may be implemented by a wireless communication device 102. The wireless communication device 102 may include a first RAT 108 (e.g., first RAT module 108) and a second RAT 110 (e.g., second RAT module 110). In one configuration, the first RAT 108 may be LTE and the second RAT 110 may be Bluetooth (BT). The first RAT 108 and the second RAT 110 may be coupled to a shared antenna 136. The shared antenna 136 may be allocated to the second RAT 110 when the second RAT 110 is active. Furthermore, the shared antenna 136 may be allocated to the first RAT 108 when the second RAT 110 is inactive.

The wireless communication device 102 may determine 202 channel quality report timing 112 for the first RAT 108. The first RAT 108 may receive the channel quality report timing 112 from a base station 104. The channel quality report timing 112 may be a schedule for when the first RAT 108 sends a channel quality report 114 to the base station 104. Among other channel quality information, the channel quality report 114 may include an indication of the MIMO rank that is available for the first RAT 108. The MIMO rank may be higher-rank MIMO when the shared antenna 136 is allocated to the first RAT 108. The MIMO level may be lower-rank MIMO when the shared antenna 136 is allocated to the second RAT 110.

The wireless communication device 102 may align 204 scan timing 124 for the second RAT 110 with the channel quality report timing 112 of the first RAT 108. The wireless communication device 102 may perform a scan according to the scan timing 124. For example, the second RAT 110 may periodically wake up at a scan start time 126 and perform a scan for one or more second RAT devices 139. At the scan end time 128, the second RAT module 110 may enter idle mode. The wireless communication device 102 may adjust the scan start time 126 and the scan end time 128 to occur when the first RAT module 108 sends a channel quality report 114.

In one configuration, the wireless communication device 102 may adjust the scan start time 126 to align with sending the first channel quality report 114a for the first RAT 108. The alignment module 130 may adjust the scan end time 128 to align with sending a second channel quality report 114b for the first RAT 108.

The wireless communication device 102 may send 206 a first channel quality report 114a to the base station 104 that indicates lower-rank MIMO is available for the first RAT 108 when the second RAT performs a scan. For example, when the wireless communication device 102 switches the shared antenna 136 to the second RAT 110 to perform a scan, the first RAT module 108 may send 206 the first channel quality report 114a to the base station 104. The first channel quality report 114a may include a lower-rank MIMO indication 116, which indicates that the shared antenna 136 is not available for MIMO operations.

The wireless communication device 102 may send 208 a second channel quality report 114b to the base station 104 that indicates higher-rank MIMO is available upon completion of the scan. For example, when the second RAT 110 completes the scan, the wireless communication device 102 may allocate the shared antenna 136 to the first RAT 108. The first RAT 108 may send 208 the second channel quality report 114b to the base station 104. The second channel quality report 114b may include a higher-rank MIMO indication 120, which indicates that the shared antenna 136 is available for MIMO operations.

FIG. 3 is a graph illustrating a non-aligned scenario 340 and an aligned scenario 342 for multiple RAT operation. A wireless communication device 102 may include a first RAT 108 and a second RAT 110 as described in connection with FIG. 1. In one configuration, the first RAT 108 may be LTE and the second RAT 110 may be Bluetooth. The first RAT 108 and the second RAT 110 may be coupled to a shared antenna 136.

The shared antenna 136 may be allocated to the second RAT 110 when the second RAT 110 is active. For example, the shared antenna 136 may be provided to the second RAT 110 when the second RAT 110 performs a scan. Furthermore, the shared antenna 136 may be allocated to the first RAT when the second RAT 110 is inactive. For example, the shared antenna 136 may be provided to the first RAT 108 when the second RAT 110 completes the scan and goes idle.

In a non-aligned scenario 340, scan timing 124 of the second RAT 110 is not aligned with the channel quality report timing 112 of the first RAT 108. In the non-aligned scenario 340, the second RAT 110 is initially idle. Therefore, the shared antenna 136 is available to the first RAT 108 for higher-rank MIMO operation. The first RAT 108 may send 301 a channel quality report 114 to the base station 104 that indicates higher-rank MIMO is available. The base station 104 may schedule a DL packet 106 for higher-rank MIMO to take advantage of the available shared antenna 136.

In the middle of higher-rank MIMO transmission of the DL packet 106, the second RAT 110 starts 303 a scan 309. At this point, the shared antenna 136 is switched over to the second RAT 110 and the first RAT 108 no longer has the shared antenna 136 available for MIMO operation. Therefore, the DL packet 106 starts dropping 305 because the first RAT 108 cannot receive a higher-rank MIMO transmission with fewer available antennas 134.

During the scan 309, the first RAT 108 may send 307 a channel quality report 114 indicating that lower-rank MIMO is available. The base station 104 may schedule a DL packet 106 for the lower-rank MIMO to account for the loss of the shared antenna 136 to the first RAT 108. However, before the first RAT 108 sends 315 another channel quality report 114, the scan 309 ends 311. The shared antenna 136 is again allocated to the first RAT 108.

During the interval after the scan 309 completes and before the first RAT 108 sends 315 another channel quality report 114, the shared antenna 136 is available to the first RAT 108 for MIMO operations. However, the base station 104 has scheduled lower-rank MIMO until the next channel quality report 114 is sent 315. Therefore, the first RAT 108 experiences a spectrum efficiency loss 313 where the first RAT 108 could take advantage of the shared antenna 136 for higher-rank MIMO, but cannot because lower-rank MIMO was reported to the base station 104.

Upon sending 315 a channel quality report 114 that indicates higher-rank MIMO is available, the first RAT 108 may switch to higher-rank MIMO. The first RAT 108 may continue higher-rank MIMO operation until a second scan 317 begins and the shared antenna 136 is switched back to the second RAT 110, at which point the DL packet 106 may start dropping. The first RAT 108 may send 319 another channel quality report 114 indicating that lower-rank MIMO is available. This cycle of dropped packets followed by spectrum efficiency loss may be repeated due to the scan timing 124 being out of alignment with the channel quality report timing 112.

In the aligned scenario 342, the scan timing 124 of the second RAT 110 is aligned with the channel quality report timing 112 of the first RAT 108. Because the channel quality report timing 112 of the first RAT 108 is fixed by the base station 104, the channel quality report timing 112 may not be adjusted by the wireless communication device 102. Instead, the scan timing 124 may be adjusted to synchronize with the channel quality report timing 112. Therefore, in the aligned scenario 342, the scan start time 126 and the scan end time 128 coincide with the times that the first RAT 108 send a channel quality reports 114.

When the second RAT 110 starts 323 a scan 325, the first RAT 108 may send 321 a channel quality report 114 indicating that lower-rank MIMO is available. The base station 104 may then schedule lower-rank MIMO based on this channel quality report 114. Because the scan timing 124 is aligned with the channel quality report timing 112, the first RAT 108 notifies the base station 104 of a change in available antennas for MIMO when the shared antenna 136 is switched to the second RAT 110. Therefore, the format of the DL packet 106 corresponds to the number of available antennas 134 during the entire scan 325 interval. The wireless communication device 102 avoids dropping the DL packet 106.

At the end 327 of the scan 325, the first RAT 108 may send 329 a channel quality report 114 indicating that higher-rank MIMO is available. The base station 104 may then schedule higher-rank MIMO based on this channel quality report 114. Because the scan timing 124 is aligned with the channel quality report timing 112, the first RAT 108 notifies the base station 104 of a change in available antennas for MIMO when the shared antenna 136 is switched to the first RAT 108. Therefore, the first RAT 108 may switch to higher-rank MIMO upon completion of the scan 325 without a spectrum efficiency loss.

The first RAT 108 may continue higher-rank MIMO operation until a second scan 333 begins and the shared antenna 136 is switched back to the second RAT 110. The first RAT 108 may send 331 a channel quality report 114 indicating that lower-rank MIMO is available during the scan 333. Upon completion of the scan 333, the first RAT 108 may send 335 a channel quality report 114 indicating that higher-rank MIMO is available.

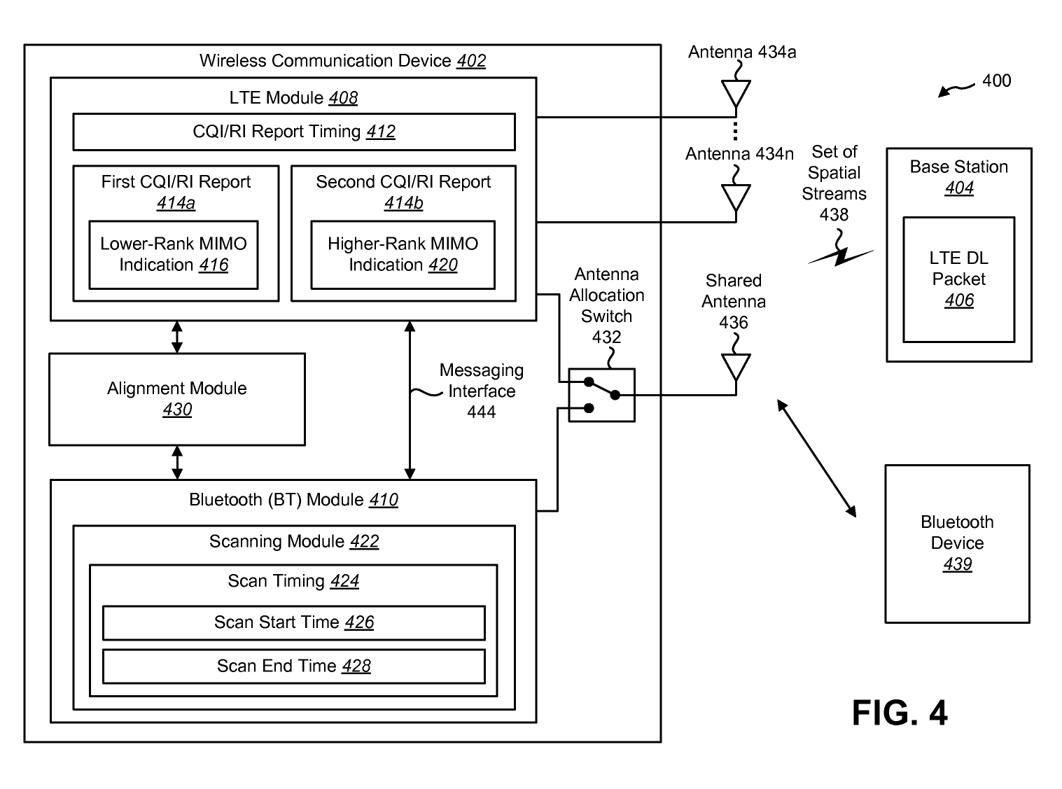

FIG. 4 is a block diagram illustrating a detailed configuration of a wireless communication device 402 in which systems and methods for aligning multiple RATs may be implemented. The wireless communication system 400 may include the wireless communication device 402, one or more base stations 404 and one or more Bluetooth (BT) devices 439. The wireless communication device 402 may be implemented in accordance with the wireless communication device 102 and the base station 404 may be implemented in accordance with the base station 104 described in connection with FIG. 1.

In some configurations, the wireless communication device 402 may communicate with other wireless devices using multiple RATs. For example, the wireless communication device 402 may include an LTE module 408 that may implement LTE communication with the base station 404. The wireless communication device 402 may also include a BT module 410 that may implement BT communication with one or more BT devices 439.

The LTE module 408 and the BT module 410 may share some common resources. The LTE module 408 and the BT module 410 may share one or more antennas 436. In FIG. 4, the wireless communication device 402 includes a shared antenna 436 that is coupled to the LTE module 408 and the BT module 410. The shared antenna 436 may be allocated to either the LTE module 408 or the BT module 410 via an antenna allocation switch 432. When the BT module 410 is active (e.g., performing an activity that uses the shared antenna 436), the shared antenna 436 may be allocated (e.g., switched) to the BT module 410. When the BT module 410 is not active (e.g., idle or not performing an activity that uses the shared antenna 436), the shared antenna 436 may be allocated to the LTE module 408.

The LTE module 408 may use MIMO to communicate with the base station 404. With MIMO, the LTE module 408 may use multiple antennas to transmit and receive data. The LTE module 408 may be coupled to multiple antennas 434a-n that are not shared with the BT module 410. The LTE module 408 may perform MIMO operations using just the non-shared antennas 434a-n. The LTE module 408 may also perform MIMO operations using the non-shared antennas 434a-n and the shared antenna 436.

The LTE module 408 may periodically feedback the MIMO rank to the base station 404. The LTE module 408 may send a CQI/RI report 414 that includes a channel quality indicator (CQI) and a rank indicator (RI). The RI may indicate the MIMO rank that is available for the LTE module 408. For example, the RI may correspond to the number of useful transmission layers for spatial multiplexing. In other words, the RI may indicate the number of spatial streams 438 that may be used for MIMO communication.

The CQI/RI report 414 may be sent to the base station 404 on a periodic basis. The LTE module 408 may follow a CQI/RI report timing 412 for sending the CQI/RI report 414. The CQI/RI report timing 412 may be scheduled by the base station 404. Therefore, the CQI/RI report timing 412 may be fixed. In the case of LTE, the LTE module 408 may send a CQI/RI report 414 to the base station 404 every 10 milliseconds (ms).

MIMO scheduling may be configured by the base station 404 based on the CQI/RI report 414 sent by the LTE module 408. If the CQI/RI report 414 indicates that higher-rank MIMO is available, the base station 404 may schedule a downlink (DL) packet 406 with a number of spatial streams 438 corresponding to the high rank. If the CQI/RI report 414 indicates that lower-rank MIMO is available, the base station 404 may schedule a DL packet 406 with a number of spatial streams 438 corresponding to the low rank.

The BT module 410 may alternate between periods of activity and inactivity. When the BT module 410 is active, the wireless communication device 402 may allocate the shared antenna 436 to the BT module 410. When the BT module 410 is inactive (e.g., idle), the wireless communication device 402 may allocate the shared antenna 436 to the LTE module 408.

The BT module 410 may perform scans for BT devices 439. In one configuration, the BT module 410 may include a scanning module 422 to perform a scan. The scan may be a paging scan or an inquiry scan. The BT module 410 may perform the scan to find one or more nearby BT devices 439 or stay connected to a previously discovered BT device 439. A BT scan may also be referred to as a BT sniff.

The scanning module 422 may perform a scan according to a scan timing 424. The BT module 410 may periodically wake up at a scan start time 426 and the scanning module 422 may perform a scan for the BT devices 439. At the scan end time 428, the BT module 410 may enter idle mode. According to BT standards, the BT module 410 may wake up for 10 ms every 1.28 sec to perform a scan. Therefore, at the scan start time 426 when the BT module 410 becomes active, the wireless communication device 402 may allocate the shared antenna 436 to the BT module 410 to perform a scan. At the scan end time 428 when the BT module 410 becomes inactive, the wireless communication device 402 may allocate the shared antenna 436 to the LTE module 408.

Switching the shared antenna 436 between the LTE module 408 and the BT module 410 may result in dropped LTE DL packets 406 or network resource inefficiencies if the scan timing 424 of the BT module 410 is not aligned with the CQI/RI report timing 412 of the LTE module 408. The wireless communication device 402 may include an alignment module 430 to align the scan timing 424 of the BT module 410 with the CQI/RI report timing 412 of the LTE module 408. The alignment module 430 may communicate with the LTE module 408 and the BT module 410.

The alignment module 430 may determine the CQI/RI report timing 412 for the LTE module 408. As discussed above, the LTE module 408 may receive the CQI/RI report timing 412 from the base station 404. The alignment module 430 may determine when the LTE module 408 is scheduled to send channel quality reports 414.

The alignment module 430 may align the scan timing 424 for the BT module 410 with the CQI/RI report timing 412 of the LTE module 408. The scan timing 424 for the BT module 410 may be adjusted, as compared to the CQI/RI report timing 412 of the LTE module 408, which is fixed by the base station 404. The alignment module 430 may adjust the scan start time 426 and the scan end time 428 to occur when the LTE module 408 sends a CQI/RI report 414. Therefore, the shared antenna 436 availability is consistent with the DL scheduling for the LTE module 408.

In one configuration, the alignment module 430 may adjust the scan start time 426 to align with sending a first CQI/RI report 414a for the LTE module 408. The alignment module 430 may adjust the scan end time 428 to align with sending a second CQI/RI report 414b for the LTE module 408.

In another configuration, the wireless communication device 402 may align the scan timing 424 for the BT module 410 with the CQI/RI report timing 412 of the LTE module 408 without an alignment module 430. For example, the wireless communication device 402 may include a messaging interface 444 between the LTE module 408 and the BT module 410. The messaging interface 444 may enable the LTE module 408 and the BT module 410 to exchange information with each other. Therefore, the BT module 410 may determine the CQI/RI report timing 412 via the messaging interface 444. The BT module 410 may then align its scan timing 424 with the CQI/RI report timing 412.

When the wireless communication device 402 switches the shared antenna 436 to the BT module 410 to perform a scan, the LTE module 408 may send the first CQI/RI report 414a to the base station 404. The first CQI/RI report 414a may indicate that lower-rank MIMO is available for the LTE module 408. In one configuration, the lower-rank MIMO indication 416 may be an RI included in the first CQI/RI report 414a. The RI may indicate the number of antennas 434 available for MIMO operations.

The LTE module 408 may switch to the lower-rank MIMO based on the first CQI/RI report 414a. Because the scan start time 426 is adjusted to align with sending the first CQI/RI report 414a for the LTE module 408, the base station 404 may schedule lower-rank MIMO when the BT module 410 starts the scan. By aligning the scan start time 426 with the first CQI/RI report 414a, the base station 404 is notified that the LTE module 408 has fewer antennas available when the BT module 410 starts the scan. In this case, the LTE module 408 may perform lower-rank MIMO operations using the two or more non-shared antennas 434a-n during the scan interval.

When the BT module 410 completes the scan, the wireless communication device 402 may allocate the shared antenna 436 to the LTE module 408. The LTE module 408 may send the second CQI/RI report 414b to the base station 404. The second CQI/RI report 414b may indicate that higher-rank MIMO is available for the LTE module 408. In one configuration, the higher-rank MIMO indication 420 may be an RI included in the first CQI/RI report 414a.

The LTE module 408 may switch to the higher-rank MIMO based on the second CQI/RI report 414b. Because the scan end time 428 is adjusted to align with sending the second CQI/RI report 414b by the LTE module 408, the base station 404 may schedule higher-rank MIMO when the BT module 410 becomes inactive and the shared antenna 436 is available to the LTE module 408. By aligning the scan end time 428 with the second CQI/RI report 414b, the base station 404 is notified that the LTE module 408 has more antennas available when the BT module 410 completes the scan. In this case, the LTE module 408 may perform higher-rank MIMO operations using the shared antenna 436 and the two or more non-shared antennas 434a-n.

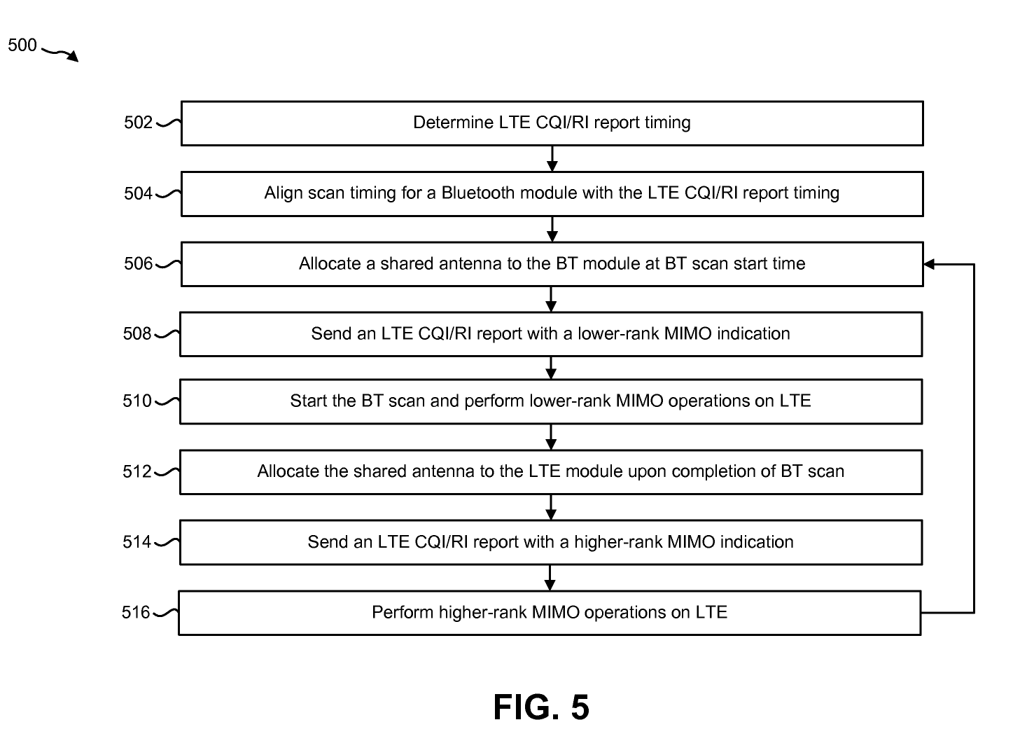

FIG. 5 is a flow diagram illustrating a method 500 for aligning multiple radio access technologies (RATs). The method 500 may be implemented by a wireless communication device 402. The wireless communication device 402 may include an LTE module 408 and a BT module 410. The LTE module 408 and the BT module 410 may be coupled to a shared antenna 436. The shared antenna 436 may be allocated to the BT module 410 when the BT module 410 is active. Furthermore, the shared antenna 436 may be allocated to the LTE module 408 when the BT module 410 is inactive.

The wireless communication device 402 may determine 502 CQI/RI report timing 412 for the LTE module 408. The LTE module 408 may receive the CQI/RI report timing 412 from a base station 404. The CQI/RI report timing 412 may instruct the LTE module 408 when to send a CQI/RI report 414 to the base station 404.

The wireless communication device 402 may align 504 scan timing 424 for the BT module 410 with the CQI/RI report timing 412 of the LTE module 408. For example, the wireless communication device 402 may adjust the scan start time 426 and the scan end time 428 to occur when the LTE module 408 sends a CQI/RI report 414.

The wireless communication device 402 may allocate 506 the shared antenna 436 to the BT module 410. At the scan start time 426, the shared antenna 436 may be switched to the BT module 410 to perform a scan.

The wireless communication device 402 may send 508 a CQI/RI report 414 with a lower-rank MIMO indication 416 to the base station 404. For example, the RI may indicate that lower-rank MIMO is available for the LTE module 408 because the shared antenna 436 is no longer available to the LTE module 408. The base station 404 may schedule lower-rank MIMO for the LTE module 408 based on the lower-rank MIMO indication 416.

The wireless communication device 402 may start 510 the BT scan and perform lower-rank MIMO operations on LTE. For example, while the BT module 410 performs a scan, the LTE module 408 may receive an LTE DL packet 406 formatted for lower-rank MIMO.

Upon completion of the BT scan, the wireless communication device 402 may allocate 512 the shared antenna 436 to the LTE module 408. The wireless communication device 402 may send 514 a CQI/RI report 414 with a higher-rank MIMO indication 420 to the base station 404. For example, the RI may indicate that higher-rank MIMO is available for the LTE module 408 because the shared antenna 436 is now available to the LTE module 408. The base station 404 may schedule higher-rank MIMO for the LTE module 408.

The wireless communication device 402 may perform 516 higher-rank MIMO operations on LTE. For example, the LTE module 408 may receive an LTE DL packet 406 formatted for lower-rank MIMO.

At the next scan start time 426, the wireless communication device 402 may reallocate 506 the shared antenna 436 to the BT module 410 to perform a scan. The wireless communication device 402 may also send 508 another CQI/RI report 414 with a lower-rank MIMO indication 416 to the base station 404. This cycle may continue until the wireless communication device 402 performs a realignment with the current base station 404 or moves to another base station 404 and aligns the scan timing 424 with the CQI/RI report timing 412 of the new base station 404.

FIG. 6 is a block diagram of a transmitter 669 and receiver 670 in a multiple-input and multiple-output (MIMO) system 600. In the transmitter 669, traffic data for a number of data streams is provided from a data source 652 to a transmit (TX) data processor 653. Each data stream may then be transmitted over a respective transmit antenna 656a through 656t. The transmit (TX) data processor 653 may format, code, and interleave the traffic data for each data stream based on a particular coding scheme selected for that data stream to provide coded data.

A MIMO system 600 may employ multiple (N_{T}) transmit antennas 656 and multiple (N_{R}) receive antennas 661 for data transmission. A MIMO channel formed by the N_{T} transmit antennas 656 and N_{R} receive antennas 661 may be decomposed into N_{S} independent channels, which are also referred to as spatial channels. The N_{S} independent channels may be less than or equal to min{N_{T}, N_{R}}. Each of the N_{S} independent channels corresponds to a dimension. The MIMO system 600 may provide improved performance (e.g., higher throughput and greater reliability) if the additional dimensionalities created by the multiple transmit antennas 656 and receive antennas 661 are utilized.

A MIMO system 600 may support time division duplex (TDD) and frequency division duplex (FDD) systems. In a TDD system, the uplink and downlink transmissions are on the same frequency region so that the reciprocity principle allows the estimation of the downlink channel from the uplink channel. This enables the base station 104 to extract transmit beamforming gain on the downlink when multiple antennas are available at the base station 104.

In one configuration, each data stream is transmitted over a respective transmit antenna 656. The TX data processor 653 formats, codes, and interleaves the traffic data for each data stream based on a particular coding scheme selected for that data stream to provide coded data.

The coded data for each data stream may be multiplexed with pilot data using OFDM techniques. The pilot data may be a known data pattern that is processed in a known manner and used at the receiver 670 to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input and multiple-output (MIMO) processor 654, which may further process the modulation symbols (e.g., for OFDM). The transmit (TX) multiple-input and multiple-output (MIMO) processor 654 then provides N_{T} modulation symbol streams to N_{T} transmitters (TMTR) 655a through 655t. The TX transmit (TX) multiple-input and multiple-output (MIMO) processor 654 may apply beamforming weights to the symbols of the data streams and to the antenna 656 from which the symbol is being transmitted.

Each transmitter 655 may receive and process a respective symbol stream to provide one or more analog signals, and further condition (e.g., amplify, filter and upconvert) the analog signals to provide a modulated signal suitable for transmission over the MIMO channel. N_{T} modulated signals from transmitters 655a through 655t are then transmitted from N_{T} antennas 656a through 656t, respectively.

At the receiver 670, the transmitted modulated signals are received by N_{R} antennas 661a through 661r and the received signal from each antenna 661 is provided to a respective receiver (RCVR) 662a through 662n. Each receiver 662 may condition (e.g., filter, amplify and downconvert) a respective received signal, digitize the conditioned signal to provide samples, and further process the samples to provide a corresponding “received” symbol stream.

An RX data processor 663 then receives and processes the N_{R} received symbol streams from N_{R} receivers 662 based on a particular receiver processing technique to provide N_{T} “detected” symbol streams. The RX data processor 663 then demodulates, deinterleaves and decodes each detected symbol stream to recover the traffic data for the data stream. The processing by RX data processor 663 is complementary to that performed by TX MIMO processor 654 and TX data processor 653 at transmitter system 669.

A processor 664 may periodically determine which pre-coding matrix to use. The processor 664 may store information on and retrieve information from memory 665. The processor 664 formulates a reverse link message comprising a matrix index portion and a rank value portion. The reverse link message may be referred to as channel state information (CSI). The reverse link message may comprise various types of information regarding the communication link and/or the received data stream. The reverse link message is then processed by a TX data processor 667, which also receives traffic data for a number of data streams from a data source 668, modulated by a modulator 666, conditioned by transmitters 662a through 662n, and transmitted back to the transmitter 669.

At the transmitter 669, the modulated signals from the receiver are received by antennas 656, conditioned by receivers 655, demodulated by a demodulator 658, and processed by an RX data processor 659 to extract the reverse link message transmitted by the receiver system 670. A processor 660 may receive channel state information (CSI) from the RX data processor 659. The processor 660 may store information on and retrieve information from memory 657. The processor 660 then determines which pre-coding matrix to use for determining the beamforming weights and then processes the extracted message.

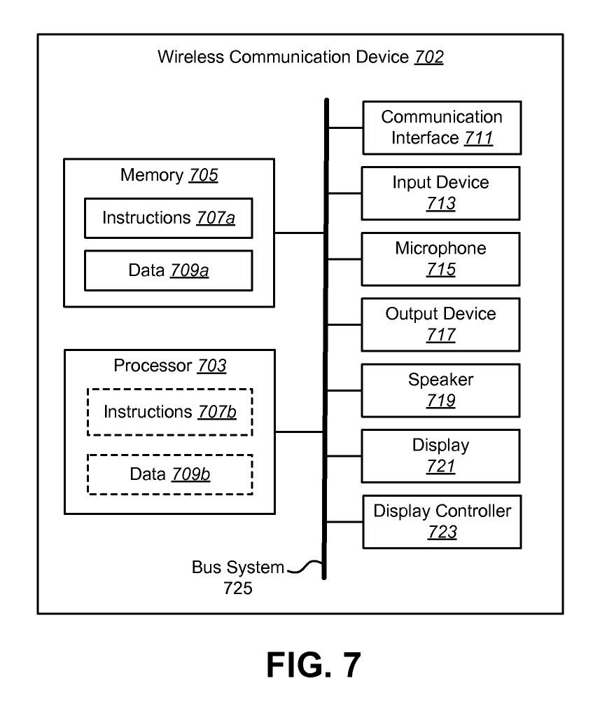

FIG. 7 illustrates various components that may be utilized in a wireless communication device 702. The illustrated components may be located within the same physical structure or in separate housings or structures. The wireless communication device 702 described in connection with FIG. 7 may be implemented in accordance with one or more of the wireless communication devices 102, 402 described herein.

The wireless communication device 702 includes a processor 703. The processor 703 may be a general purpose single- or multi-chip microprocessor (e.g., an advanced RISC machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors 703 (e.g., an ARM and DSP) could be used.

The wireless communication device 702 also includes memory 705 in electronic communication with the processor 703. That is, the processor 703 may read information from and/or write information to the memory 705. The memory 705 may be any electronic component capable of storing electronic information. The memory 705 may be random access memory (RAM), read-only memory (ROM), magnetic disk storage media, optical storage media, flash memory devices in RAM, on-board memory included with the processor 703, programmable read-only memory (PROM), erasable programmable read-only memory (EPROM), electrically erasable PROM (EEPROM), registers, and so forth, including combinations thereof.

Data 709a and instructions 707a may be stored in the memory 705. The instructions 707a may include one or more programs, routines, sub-routines, functions, procedures, etc. The instructions may include a single computer-readable statement or many computer-readable statements. The instructions 707a may be executable by the processor 703 to implement one or more of the methods, functions and procedures described above. Executing the instructions may involve the use of the data 709a that is stored in the memory 705. FIG. 7 shows some instructions 707b and data 709b being loaded into the processor 703 (which may come from instructions 707a and data 709a that are stored in the memory 705).

The wireless communication device 702 may also include one or more communication interfaces 711 for communicating with other wireless communication devices. The communication interfaces 711 may be based on wired communication technology, wireless communication technology, or both. Examples of different types of communication interfaces 711 include a serial port, a parallel port, a Universal Serial Bus (USB), an Ethernet adapter, an Institute of Electrical and Electronics Engineers (IEEE) 1394 bus interface, a near-field communication (NFC) transceiver, a small computer system interface (SCSI) bus interface, an infrared (IR) communication port, a Bluetooth wireless communication adapter, a 3rd Generation Partnership Project (3GPP) transceiver, an IEEE 802.11 (“Wi-Fi”) transceiver and so forth. For example, the communication interface 711 may be coupled to one or more antennas (not shown) for transmitting and receiving wireless signals.

The wireless communication device 702 may also include one or more input devices 713 and one or more output devices 717. Examples of different kinds of input devices 713 include a keyboard, mouse, microphone 715, remote control device, button, joystick, trackball, touchpad, lightpen, etc. For instance, the wireless communication device 702 may include one or more microphones 715 for capturing acoustic signals. In one configuration, a microphone 715 may be a transducer that converts acoustic signals (e.g., voice, speech) into electrical or electronic signals. Examples of different kinds of output devices 717 include a speaker 719, printer, etc. For instance, the wireless communication device 702 may include one or more speakers 719. In one configuration, a speaker 719 may be a transducer that converts electrical or electronic signals into acoustic signals. One specific type of output device 717 that may be typically included in a wireless communication device 702 is a display 721 device. Display 721 devices used with configurations disclosed herein may utilize any suitable image projection technology, such as a cathode ray tube (CRT), liquid crystal display (LCD), light-emitting diode (LED), gas plasma, electroluminescence, or the like. A display controller 723 may also be provided, for converting data stored in the memory 705 into text, graphics, and/or moving images (as appropriate) shown on the display 721 device.

The various components of the wireless communication device 702 may be coupled together by one or more buses, which may include a power bus, a control signal bus, a status signal bus, a data bus, etc. For simplicity, the various buses are illustrated in FIG. 7 as a bus system 725. It should be noted that FIG. 7 illustrates only one possible configuration of a wireless communication device 702. Various other architectures and components may be utilized.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2 and FIG. 5 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
determining channel quality report timing for a first radio access technology (RAT);
aligning scan timing for a second RAT with the channel quality report timing of the first RAT;
sending a first channel quality report to a base station that indicates lower-rank multiple-input and multiple-output (MIMO) is available for the first RAT when the second RAT performs a scan; and
sending a second channel quality report to the base station that indicates higher-rank MIMO is available upon completion of the scan.

2. The method of claim 1, wherein aligning the scan timing for the second RAT with the channel quality report timing of the first RAT comprises:
adjusting a scan start time to align with sending the first channel quality report for the first RAT; and
adjusting a scan end time to align with sending the second channel quality report for the first RAT.

3. The method of claim 1, wherein the lower-rank MIMO uses fewer antennas for MIMO operations than the higher-rank MIMO.

4. The method of claim 1, further comprising:
switching to the lower-rank MIMO for the first RAT based on the first channel quality report;
starting the scan of the second RAT; and
switching to the higher-rank MIMO for the first RAT upon completion of the scan based on the second channel quality report.

5. The method of claim 1, further comprising:
allocating a shared antenna to the second RAT when the second RAT starts the scan, wherein the first RAT performs lower-rank MIMO operations using two or more non-shared antennas during a scan interval; and
allocating the shared antenna to the first RAT when the second RAT completes the scan, wherein the first RAT performs higher-rank MIMO operations using the shared antenna and the two or more non-shared antennas.

6. The method of claim 1, wherein the first RAT is Long-Term Evolution (LTE) and the second RAT is Bluetooth (BT).

7. The method of claim 1, wherein the channel quality report comprises a channel quality indicator (CQI) and a rank indicator (RI).

8. The method of claim 1, wherein the method is performed by a wireless communication device.

9. A wireless communication device, comprising:
a processor;
memory in electronic communication with the processor; and
instructions stored in the memory, the instructions being executable by the processor to:
determine channel quality report timing for a first radio access technology (RAT);
align scan timing for a second RAT with the channel quality report timing of the first RAT;
send a first channel quality report to a base station that indicates lower-rank multiple-input and multiple-output (MIMO) is available for the first RAT when the second RAT performs a scan; and
send a second channel quality report to the base station that indicates higher-rank MIMO is available upon completion of the scan.

10. The wireless communication device of claim 9, wherein the instructions executable to align the scan timing for the second RAT with the channel quality report timing of the first RAT comprise instructions executable to:
adjust a scan start time to align with sending the first channel quality report for the first RAT; and
adjust a scan end time to align with sending the second channel quality report for the first RAT.

11. The wireless communication device of claim 9, wherein the lower-rank MIMO uses fewer antennas for MIMO operations than the higher-rank MIMO.

12. The wireless communication device of claim 9, further comprising instructions executable to:
switch to the lower-rank MIMO for the first RAT based on the first channel quality report;
start the scan of the second RAT; and
switch to the higher-rank MIMO for the first RAT upon completion of the scan based on the second channel quality report.

13. The wireless communication device of claim 9, further comprising instructions executable to:
allocate a shared antenna to the second RAT when the second RAT starts the scan, wherein the first RAT performs lower-rank MIMO operations using two or more non-shared antennas during a scan interval; and
allocate the shared antenna to the first RAT when the second RAT completes the scan, wherein the first RAT performs higher-rank MIMO operations using the shared antenna and the two or more non-shared antennas.

14. The wireless communication device of claim 9, wherein the first RAT is Long-Term Evolution (LTE) and the second RAT is Bluetooth (BT).

15. An apparatus, comprising:
means for determining channel quality report timing for a first radio access technology (RAT);
means for aligning scan timing for a second RAT with the channel quality report timing of the first RAT;
means for sending a first channel quality report to a base station that indicates lower-rank multiple-input and multiple-output (MIMO) is available for the first RAT when the second RAT performs a scan; and
means for sending a second channel quality report to the base station that indicates higher-rank MIMO is available upon completion of the scan.

16. The apparatus of claim 15, wherein the means for aligning the scan timing for the second RAT with the channel quality report timing of the first RAT comprise:
means for adjusting a scan start time to align with sending the first channel quality report for the first RAT; and
means for adjusting a scan end time to align with sending the second channel quality report for the first RAT.

17. The apparatus of claim 15, wherein the lower-rank MIMO uses fewer antennas for MIMO operations than the higher-rank MIMO.

18. The apparatus of claim 15, further comprising:
means for switching to the lower-rank MIMO for the first RAT based on the first channel quality report;
means for starting the scan of the second RAT; and
means for switching to the higher-rank MIMO for the first RAT upon completion of the scan based on the second channel quality report.

19. The apparatus of claim 15, further comprising:
means for allocating a shared antenna to the second RAT when the second RAT starts the scan, wherein the first RAT performs lower-rank MIMO operations using two or more non-shared antennas during a scan interval; and
means for allocating the shared antenna to the first RAT when the second RAT completes the scan, wherein the first RAT performs higher-rank MIMO operations using the shared antenna and the two or more non-shared antennas.

20. The apparatus of claim 15, wherein the first RAT is Long-Term Evolution (LTE) and the second RAT is Bluetooth (BT).
